(19) United States
(12) Patent Application Publication
(10) Pub. No.: US 2014/0327250 A1
(43) Pub. Date: Nov. 6, 2014

(54) DOOR LOCK APPARATUS

(71) Applicant: SHIROKI CORPORATION, FUJISAWA-SHI, KANAGAWA (JP)

(72) Inventors: Kazuo Goto, Fujisawa-shi (JP); Yoshiki Ishikawa, Toyota-shi (JP)

(73) Assignee: SHIROKI CORPORATION, FUJISAWA-SHI, KANAGAWA (JP)

(21) Appl. No.: 14/360,673

(22) PCT Filed: Nov. 21, 2012
(86) PCT No.: PCT/JP2012/080166

§ 371 Date: May 27, 2014

(30) Foreign Application Priority Data
Nov. 28, 2011 (JP) 2011-258601

(51) Int. Cl. E05C 3/02

(52) U.S. Cl. CPC E05C 3/02
USPC 292/194

(57) ABSTRACT

A door lock apparatus is provided, which includes a door trim provided on a vehicle interior side of a door, which is capable of being opened and closed with respect to a vehicle body; a door lock body provided on the door to lock and unlock the door; a lock cover which covers a projecting portion, of the door lock body, which projects from the door trim; and a fixer which fixes the lock cover and the door trim to each other. By fixing the lock cover to the door trim using the fixer, the position accuracy between the door trim and the door lock body is improved and the stability of the door trim is improved.

### TECHNICAL FIELD

The present invention relates to a door lock apparatus for locking and unlocking a door installed in a vehicle, and in particular relates to a protective structure of a door lock apparatus.

### BACKGROUND ART

In this type of door lock apparatus, a hook (latch) and a ratchet (pawl) are supported on a base plate, and upon the hook which is engaged with a striker being rotated to the striker holding position (in the striker draw-in direction) when the door is closed, the ratchet engages with the hook to thereby prevent the hook from rotating in the striker releasing direction, thereby causing the door to enter a locked state. When the door is opened, rotating the ratchet in a direction (unlatching direction) to make the ratchet disengaged from the hook causes the hook to allow the striker to be released, thus allowing the door to be opened.

In the case of providing a body part of the door lock apparatus that includes the hook and the ratchet on the door side and providing the striker on the vehicle body side, part of the door lock body (a portion which supports the hook and the ratchet) provided on the door side needs to be exposed from the door to make the entry of the striker possible. A structure is known in which a lock cover which covers the outwardly exposed portion of the door lock body other than the approach path for the striker is provided to protect mechanisms such as the hook and the ratchet and to improve the outward appearance.

### CITATION LIST

### Patent Literature

Patent Literature 1: Japanese Patent No. 4,742,364.

### SUMMARY OF INVENTION

### Technical Problem

The lock cover is in the shape of a box which allows a portion of the base plate, which constitutes a component of the door lock apparatus, to be inserted, and the door lock apparatus is fixed to a door panel of a door with the lock cover attached so as to cover the door lock apparatus. A door trim as an interior decorating member is mounted to the vehicle interior side of the door panel; however, conventionally, the door lock apparatus and the lock cover are not fastened to the door trim, so that it has been difficult to precisely position the door lock apparatus and the door trim relative to each other. In addition, there is also a possibility of the door trim vibrating (rattling) to make a noise when the door is opened and closed since the door trim is not fixed to the door panel in the vicinity of the door lock apparatus.

The present invention has been devised in view of the above described problems, and the present invention provides a door lock apparatus which contributes to improvement in position accuracy between the door trim and the door lock body and improvement in stability of the door trim.

### Solution to Problem

The present invention is characterized by a door lock apparatus including a door trim provided on a vehicle interior side of a door, which is capable of being opened and closed with respect to a vehicle body; a door lock body provided on the door to lock and unlock the door; a lock cover which covers a projecting portion, of the door lock body, which projects from the door trim; and a fixer which fixes the lock cover and the door trim to each other.

The lock cover can include a cover body which covers the projecting portion of the door lock body that projects from the door trim; and a support tongue which projects from the cover body and extends in a direction along a wall surface of the door trim, wherein the door trim is fixed to the support tongue. It is desirable for the lock cover to be molded using a molding die which is parted in an opening direction of an opening of the cover body, into which the door lock body is inserted, and for the lock cover to include a flange which extends in a parting direction of the molding die from an outer edge of the support tongue or to include a rib which extends in a parting direction of the molding die from a back surface of the support tongue.

It is advisable for the fixer to include an insertion fixing member which is inserted into holes formed through the support tongue of the lock cover and the door trim to fasten and fix the lock cover and the door trim to each other.

### Advantageous Effects of the Invention

According to the present invention, it is possible to achieve an improvement in position accuracy between the door trim and the door lock body and an improvement in stability of the door trim.

### BRIEF DESCRIPTION OF THE DRAWINGS

FIG. 1 is a diagram showing a state where a lock cover is removed from a door lock body;

FIG. 2 is a diagram showing a state where the lock cover is mounted to the door lock body;

FIG. 3 is a diagram showing a state where a combination of the door lock body and the lock cover is supported by the door trim, viewed from the vehicle interior side;

FIG. 4 is a transparent view of the door lock body shown in FIG. 3;

FIG. 5 is a diagram viewed in the direction of the arrow A shown in FIG. 3;

FIG. 6 is a cross sectional view taken along the line B-B shown in FIG. 3;

FIG. 7 is a perspective view of the lock cover;

FIG. 8 is a perspective view of the lock cover, viewed from a different angle; and

FIG. 9 is a plan view of the lock cover.

### EMBODIMENT

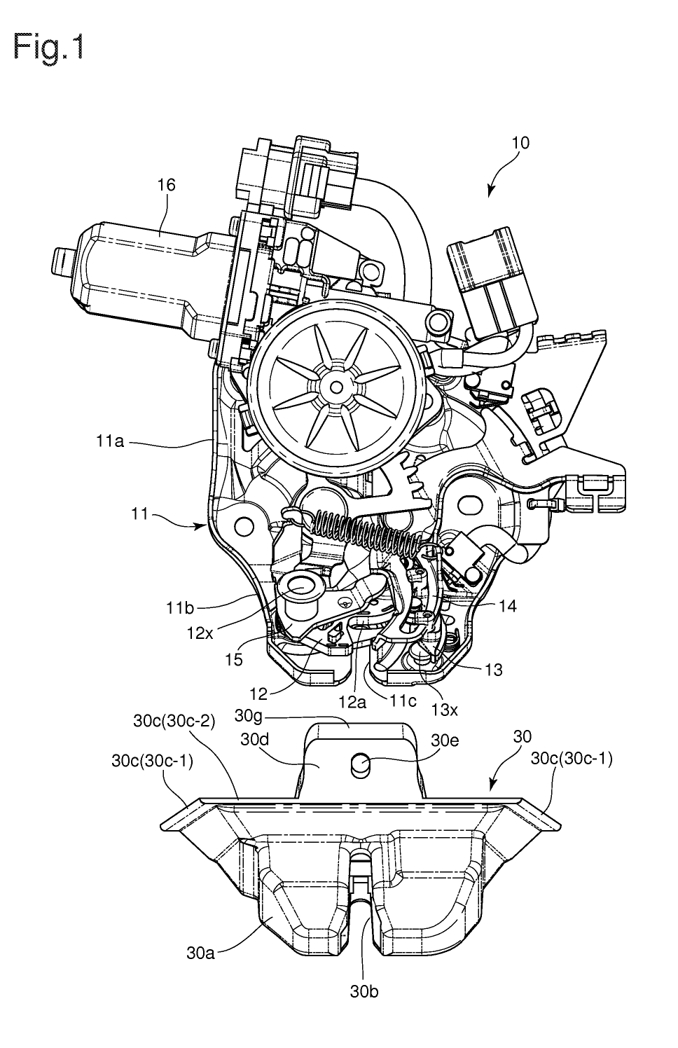

A door lock body 10 shown in FIG. 1 is installed on a vehicle door and has a structure such that a latch mechanism which is engaged with and disengaged from a striker (not shown) on a vehicle body side, not shown in the drawings, and a motorized drive mechanism which drives this latch mechanism are supported on a base plate 11. The base plate 11 is provided with a base portion 11a and a projecting portion 11b which is narrower in width than the base portion 11a, and a striker entry groove 11c is formed in the base plate 11 to extend in a direction from the end of the projecting portion 11b toward the base portion 11a. The projecting portion 11b has a shape which progressively reduces in width toward the end thereof.

The structures of the latch mechanism and the motorized drive mechanism are known in the art and will be briefly described hereinafter. As shown in FIG. 1, the base plate 11 is provided, on the projecting portion 11b on either side of the striker entry groove 11c, with a pair of rotational shafts 12x and 13x, respectively, and a hook 12 and a ratchet lever 13 are pivoted on the rotational shaft 12x and the rotational shaft 13x.

The end of the hook 12 is bifurcated, and the hook 12 has a striker holding groove 12a therebetween. The hook 12 is rotatable (swingable) between a striker holding position (the position shown in FIG. 1), in which the striker holding groove 12a is made to intersect the striker entry groove 11c, and a striker releasing position (the position rotated clockwise from the position shown in FIG. 1), in which the striker holding groove 12a is retracted from the position on the striker entry groove 11c, and the hook 12 is biased to rotate toward the striker releasing position.

The ratchet lever 13 is rotatable (swingable) between a locking position, in which the ratchet lever 13 is engaged with the hook 12 to hold the hook 12 in the striker holding position, and a lock releasing position, in which the ratchet lever 13 is disengaged from the hook 12 to allow the hook 12 to rotate toward the striker releasing position. The ratchet lever 13 is biased to rotate toward the locking position and can be rotated to the lock releasing position by operating an opening lever 14.

A closing lever 15 is supported coaxially with the hook 12. The closing lever 15 is rotated by a driving force of a motor 16 fixed to the base portion 11a and can rotate the hook 12 to the striker holding position when the striker enters the striker holding groove 12a.

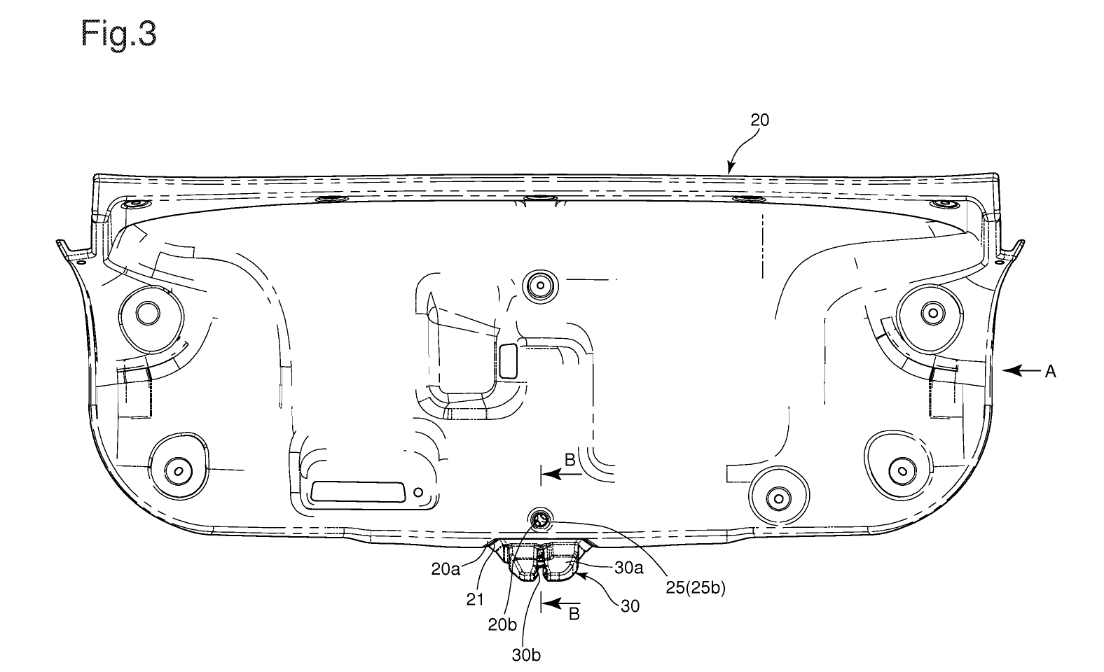

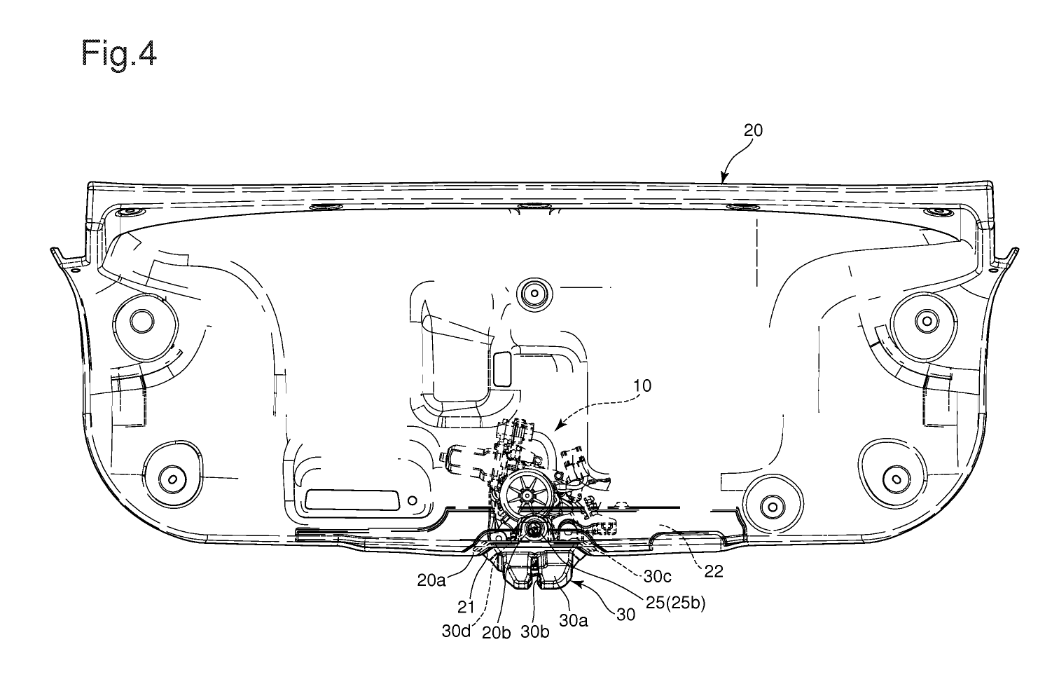

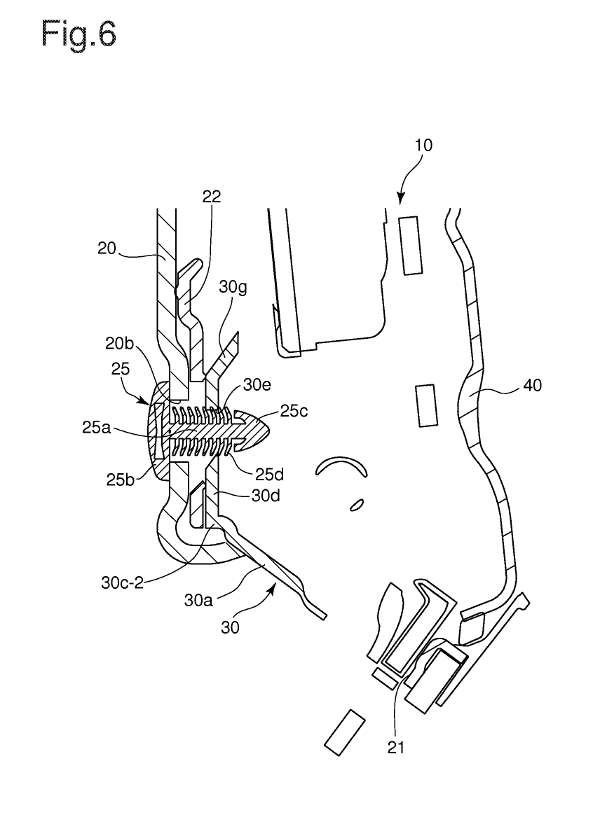

The door has an outer panel (not shown) on the vehicle exterior side and an inner panel 40 (a portion of which is shown in FIG. 6) on the vehicle interior side, and a door trim 20 which serves as an interior part is mounted to the vehicle interior side of the inner panel. The door lock body 10 is positioned between the inner panel and the door trim 20, and the base plate 11 is fixed to the inner panel 40. An opening 21 (FIGS. 3 and 4) is formed in lower parts of the door trim 20 and the inner panel 40, and the projecting portion 11b projects through the opening 21. A lock cover 30 is provided for protecting this projecting portion (specifically the hook 12, the ratchet lever 13, etc., on the projecting portion 11b of the base plate 11) of the door lock body 10 and for improving the outward appearance.

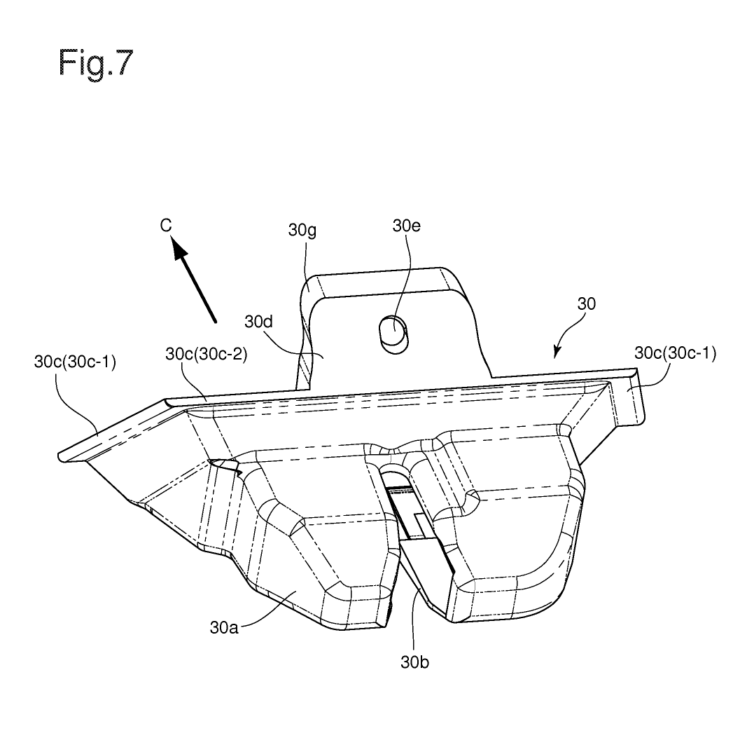

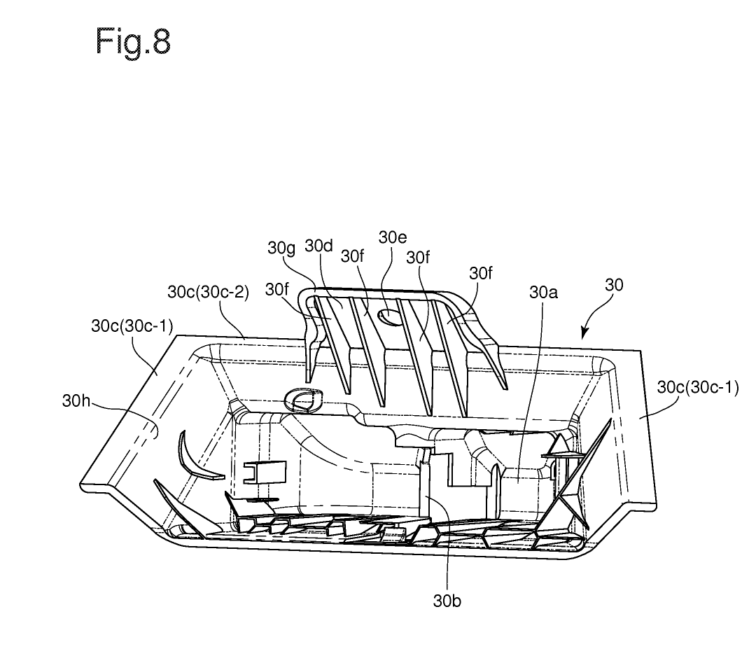

The lock cover 30 is a molded product made of synthetic resin, and is provided with a hollow cover body 30a which covers the projecting portion 11b, a slit-like striker entry hole 30b which is formed in the cover body 30a, a support flange 30c which is formed on the base end of the cover body 30a, and a support tongue 30d which projects from the cover body 30a and the support flange 30c as shown in FIGS. 7 through 9. A clip engaging hole 30e is formed through the support tongue 30d. In addition, as shown in FIG. 8, a plurality of ribs (reinforcing portions) 30f are formed on the back (on the side of the support rig 30d that is opposite from the side which faces the door trim 20 in an assembled state which will be discussed later) of the support tongue 30d to ensure strength. More specifically, the support flange 30c is provided with a pair of wide-width portions 30c-1 which are formed on both sides of the cover body 30a and a narrow-width portion 30c-2 which connects the pair of wide-width portions 30c-1, and the support tongue 30d is an upright wall portion of the narrow-width portion 30c-2 which is formed to project from the center of the narrow-width portion 30c-2. The support tongue 30d is provided on the outer edge thereof with a peripheral flange (reinforcing portion) 30g which projects toward the rear side of the support tongue 30d, and the plurality of ribs 30f are formed as plate-like portions which connect the peripheral flange 30g, the back of the support tongue 30d and an inner surface of the cover body 30a. The formation of the reinforcing ribs 30f and the peripheral flange 30g improves the strength of the support tongue 30d.

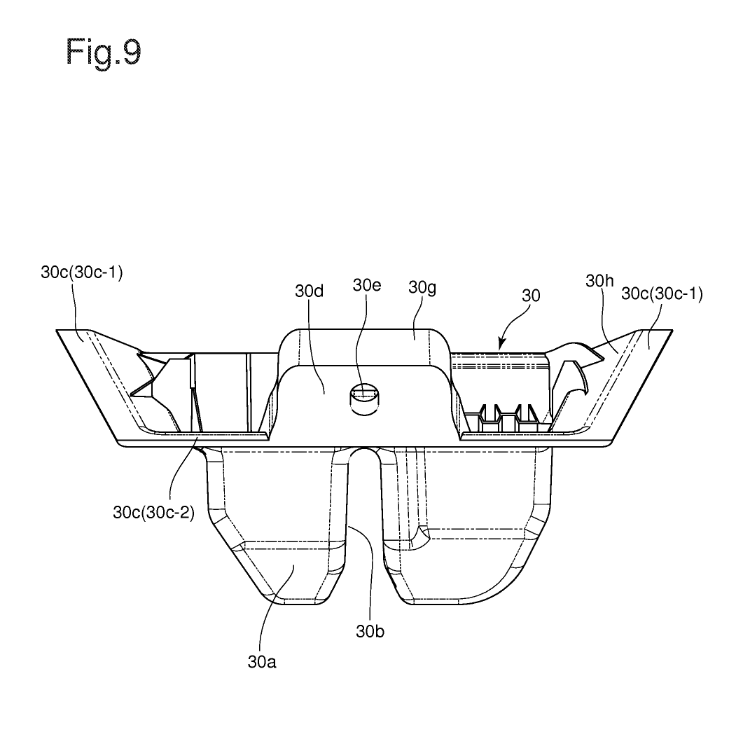

A cover opening 30h (FIGS. 8 and 9), which allows the projecting portion 11b of the base plate 11 of the door lock body 10 to enter, is formed in the cover body 30a of the lock cover 30. The support flange portion 30c is formed so as to surround the cover opening 30h, and the support tongue 30d is provided on a peripheral edge of the cover opening 30h. The lock cover 30 is molded using a molding die configured of an upper die and a lower die, and the upper die is released (parted) from the lower die in a direction shown by the arrow C in FIG. 7, i.e., in the opening direction of the cover opening 30h when the lock cover 30 is molded. The reinforcing rib 30f and the peripheral flange 30g are extended in this mold parting direction, thus being easy to produce.

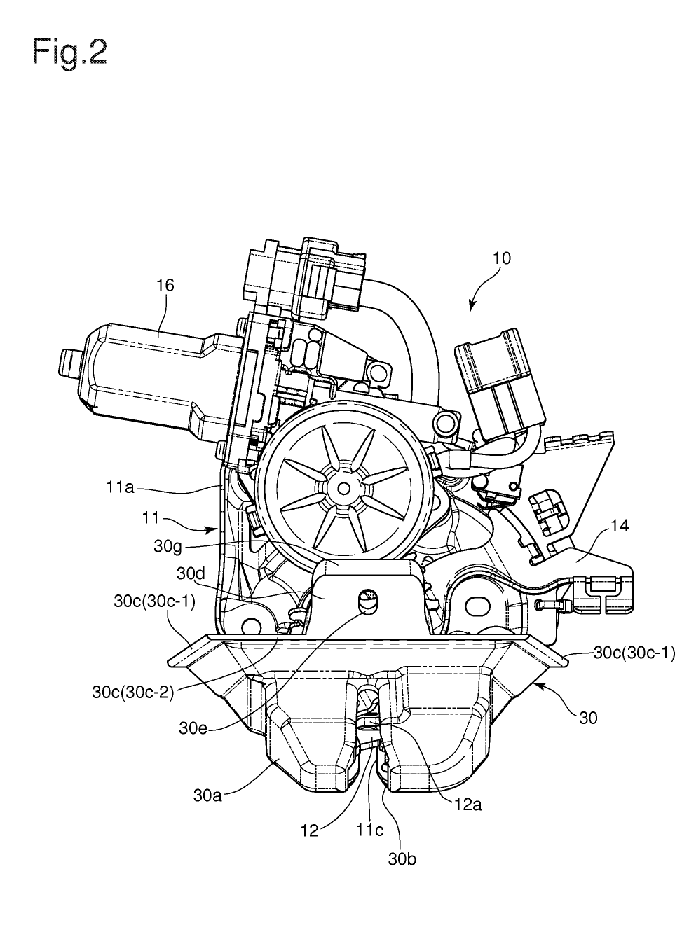

As shown in FIG. 2, the lock cover 30 is mounted to the door lock body 10 by inserting the projecting portion 11b of the base plate 11 into the cover body 30a. In this inserted state, the projecting portion 11b is press-fitted into the cover body 30a, so that the lock cover 30 does not come off the door lock body 10. The striker entry hole 30b is positioned to superpose the striker entry groove 11c of the base plate 11, so that the striker is not prevented from entering the striker entry groove 11c by the lock cover 30.

The door lock body 10 is mounted to the inner panel 40 with the lock cover 30 engaged with the door lock body 10, and the door trim 20 is mounted to the inner panel 40. A support surface 20a (FIGS. 3 through 5) which allows the support flange 30c to come into contact therewith is formed on the door trim 20 on the periphery of the opening 21, and the support flange 30c of the lock cover 30 is supported on the support surface 20a upon the door trim 20 being mounted to the inner panel 40.

In the above described mounted state, the cover body 30a of the lock cover 30 projects from the opening 21 that is formed in a lower part of the door trim 20 as shown in FIGS. 3 through 5. In other words, a projecting portion of the door lock body 10 which projects from the door trim 20 (the projecting portion 11b of the base plate 11) is covered by the cover body 30a of the lock cover 30. Accordingly, the latch mechanism, which is composed of the hook 12 and the ratchet 13 that are supported on the projecting portion 11b, is protected. In addition, the outward appearance is improved by covering the latch mechanism with the lock cover 30.

As shown in FIG. 6, in a mounted state of the door lock body 10, the door trim 20 and the lock cover 30, the support tongue 30d of the lock cover 30 is positioned along (to face) a wall surface of the door trim 20 with a reinforcing plate 22 positioned between the support tongue 30d and the door trim 20, and a clip insertion hole 20b (FIGS. 3, 4 and 6) is formed through the door trim 20 at a position opposing the clip engaging hole 30e of the support tongue 30d. The clip engaging hole 30e is set smaller in opening size (opening width) than the clip insertion hole 20b. A fastening clip (fixer/insertion fixing member) 25 (see FIGS. 3 through 6) is inserted into the clip insertion hole 20b on the door trim 20 side and the clip engaging hole 30e on the lock cover 30 side.

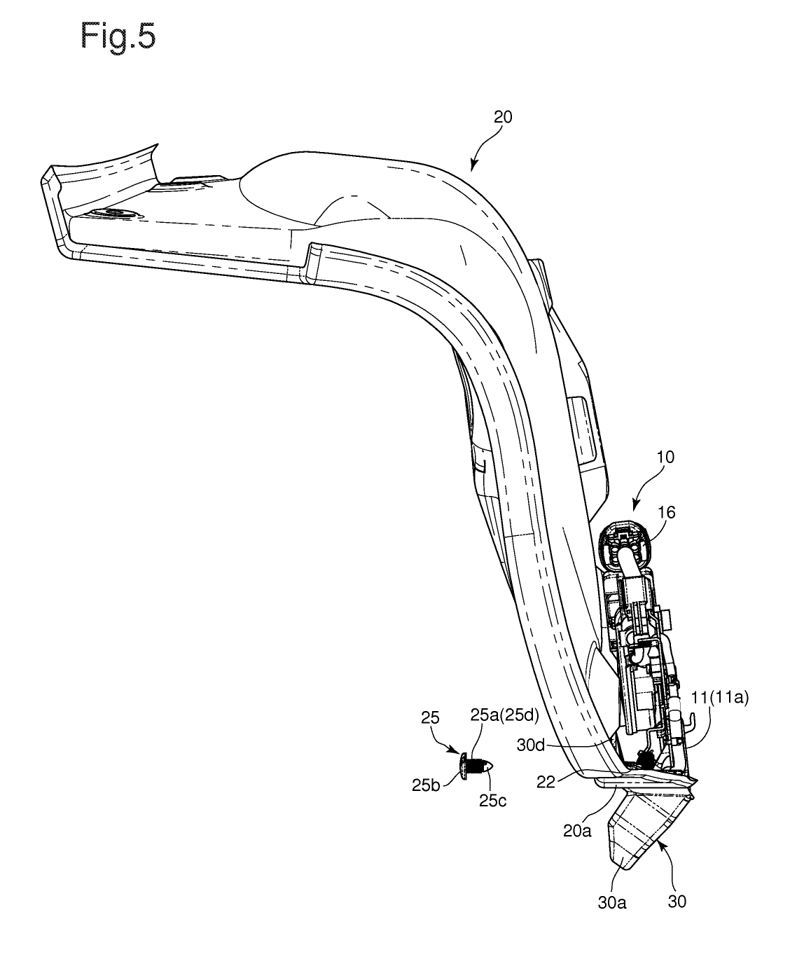

As shown in FIGS. 5 and 6, the clip 25 is provided with a shaft portion 25a and a head portion 25b, and the shaft portion 25a is provided at the tip thereof with a tapered end projection 25c having a hook-shaped cross section which increases in diameter toward the head portion 25b. The shaft portion 25a is provided, on the periphery thereof between the end projection 25c and the head portion 25b, with a plurality of thin annular retaining fins 25d which are formed successively in the axial direction. The maximum diameter of the end projection 25c and the retaining fins 25d are each greater in diameter than the inner diameter size of the clip engaging hole 30e and the end projection 25c and the retaining fins 25d are elastically deformable in a direction to reduce the diameter. The clip 25 is such that the shaft portion 25a is inserted from the clip insertion hole 20b toward the clip engaging hole 30e with the end projection 25c at the forefront. At the time of this insertion, the end projection 25c passes through the clip engaging hole 30e and subsequently a portion of the retaining fins 25d pass through the clip engaging hole 30e while being reduced in diameter, and subsequently, upon the clip 25 being inserted until the head portion 25b comes into contact with the trim 20 as shown in FIG. 6, the end projection 25c and the portion of the retaining fins 25d which have passed through the clip engaging hole 30e are positioned behind the support tongue 30d to prevent the clip 25 from moving in the direction opposite to the insertion direction. This prevents the clip 25 from coming off, so that the door trim 20 and the lock cover 30 are fastened. Fixing the door trim 20 and the lock cover 30 to each other via the clip 25 in this manner makes it possible to precisely determine the relative position between the door trim 20 and the lock cover 30 (and the door lock body 10 to which the lock cover 30 has been fitted). Additionally, there is the limitation of it being difficult to fix the door trim 20 directly to the inner panel 40 of the door on the periphery of the door lock body 10; however, by fixing the door trim 20 to the lock cover 30 using the clip 25, the door trim 20 is securely supported via the lock cover 30 and the door lock body 10, which eliminates the chances of occurrence of noise due to vibrations of the door trim 20 when the door is opened and closed.

Although the present invention has been described based on the illustrated embodiment, the present invention is not limited thereto. For instance, although only one clip 25 is used in the illustrated embodiment, the door trim 20 and the lock cover 30 can be fastened and fixed using more than one clip 25. In this case, the clip insertion holes 20b and 30e that correspond in number to the clips 25 would be formed in the door trim 20 and the lock cover 30, respectively.

Alternatively, as a device for fixing the door trim 20 and the lock cover 30, it is possible to use a hook-and-loop fastener, or a touch fastener, instead of the clip 25. More specifically, one and the other of a hook surface and a loop surface which constitute a hook-and-loop fastener can be provided on the support tongue 30d of the lock cover 30 and a wall surface of the door trim 20 which faces the support tongue 30d, respectively.

Additionally, although the door lock body 10 of the illustrated embodiment is of a type which drives the hook 12 using a motorized drive mechanism, the present invention can also be applied to a door lock apparatus not equipped with such a motorized drive mechanism.

### INDUSTRIAL APPLICABILITY

As described above in detail, the present invention can achieve an improvement in position accuracy between the door trim and the door lock body and an improvement in stability of the door trim in a door lock apparatus in which a part of the door lock body is projected from the door trim that is provided on the vehicle interior side of a door, which is capable of being opened and closed with respect to the vehicle body, and in which this projecting portion of the door lock body is covered by a lock cover.

### Reference Signs List

10 Door lock body
11 Base plate
11a Base portion
11b Projecting portion
11c Striker entry groove
12 Hook
12a Striker holding groove
13 Ratchet lever
14 Opening lever
15 Opening lever
16 Motor
20 Door trim
20a Support surface
20b Clip insertion hole
21 Opening
22 Reinforcing plate
25 Clip (fixer/insertion fixing member)
30 Lock cover
30a Cover body
30b Striker entry hole
30c Support flange
30c-1 Wide-width portion
30c-2 Narrow-width portion
30d Support tongue
30e Clip engaging hole
30f Reinforcing rib (reinforcing portion)
30g Peripheral flange (reinforcing portion)
30h Cover opening
40 Inner panel

1. A door lock apparatus comprising:
a door trim provided on a vehicle interior side of a door, which is capable of being opened and closed with respect to a vehicle body;
a door lock body provided on said door to lock and unlock said door;
a lock cover which covers a projecting portion, of said door lock body, which projects from said door trim; and
a fixer which fixes said lock cover and said door trim to each other.

2. The door lock apparatus according to claim 1, wherein said lock cover comprises:
a cover body which covers said projecting portion of said door lock body that projects from said door trim; and
a support tongue which projects from said cover body and extends in a direction along a wall surface of said door trim,
wherein said door trim is fixed to said support tongue.

3. The door lock apparatus according to claim 2, wherein said lock cover is molded using a molding die which is parted in an opening direction of an opening of said cover body, into which said door lock body is inserted, and
wherein said lock cover comprises a flange which extends in a parting direction of said molding die from an outer edge of said support tongue.

4. The door lock apparatus according to claim 2, wherein said lock cover is molded using a molding die which is parted in an opening direction of an opening of said cover body, into which said door lock body is inserted, and
wherein said lock cover comprises a rib which extends in a parting direction of said molding die from a back surface of said support tongue.

5. The door lock apparatus according to claim 2, wherein said fixer comprises an insertion fixing member which is inserted into holes formed through said support tongue of said lock cover and said door trim to fasten and fix said lock cover and said door trim to each other.
